(19) United States
(12) Patent Application Publication
(10) Pub. No.: US 2019/0307132 A1
(43) Pub. Date: Oct. 10, 2019

(54) Baking Device

(71) Applicant: HAAS FOOD EQUIPMENT GMBH, Wien (AT)

(72) Inventors: Stefan Jiraschek, Königsbrunn (AT); Michael Steinböck, Holzleiten (AT); Franz Kempf, Sierndorf (AT)

(73) Assignee: HAAS FOOD EQUIPMENT GMBH, Wien (AT)

(21) Appl. No.: 16/315,266

(22) PCT Filed: Jul. 3, 2017
(86) PCT No.: PCT/EP2017/066416

§ 371 Date: Jan. 4, 2019

(30) Foreign Application Priority Data
Jul. 6, 2016 (EP) 16178159.6

(51) Int. Cl. A21B 1/42; A21B 5/02

(52) U.S. Cl. CPC A21B 1/42; A21B 5/023

(57) ABSTRACT

A baking device (1) for producing baked products has a baking device frame (2) with a baking device housing (3) and a baking chamber (4), a baking tong chain (5) with baking tong carriages (6) which have baking tongs (21) that can be opened and closed. Rollers (7) are connected to the carriages (6) and/or to the chain (5) in such a way as to be able to rotate about a roller rotation axis (8), and roll on at least one vertical guide rail (9) in order to support and vertically guide the baking tong carriages (6). At least one lateral guide roller (10) is connected to a carriage (6) and/or to the chain (5) so as to be able to rotate about a lateral guide roller rotation axis (11). The lateral guide roller (10) rolls on at least one lateral guide strip (12) of the baking device (1) to laterally guide the carriage (6), and wherein the direction of the lateral guide roller rotation axis (11) is at an angle to the direction of the roller rotation axis (8).

### CROSS-REFERENCE TO RELATED APPLICATION(S)

This application is the National Stage of International Patent Application No. PCT/EP2017/066416 filed on Jul. 3, 2017, which claims priority from European Patent Application No. EP 16178159.6 filed on Jul. 6, 2016, both of which are herein incorporated by reference herein in their entireties.

### BACKGROUND

### Field of the Invention

The invention relates to a baking device.

### State of the Art

The prior art, for example WO 2012/152778 A1, discloses baking ovens in which slide strips are provided for laterally guiding the baking tong carriages. In generic baking devices, said slide strips are rigidly arranged on the moving baking tong carriages. For guiding the slide strips, slide rollers are provided, said slide rollers being arranged in a fixed position on the frame of the baking oven. One particular disadvantage of these conventional baking ovens is that, depending on the location and the heating concept, in some cases strongly divergent temperature loads occur for these slide rollers arranged in a fixed position in the baking oven. For instance, the thermal load on a slide roller which is arranged directly in the region of the heating means is much higher than the load on a roller which is arranged in the region of the front head, at which no heating takes place. Another disadvantage of these baking ovens is that some slide rollers in the baking oven are not directly accessible, which makes maintenance and replacement thereof more difficult. Particularly in the case of baking ovens which are equipped with fewer doors for better heat insulation, this leads to a considerable maintenance and replacement effort.

### SUMMARY

The object of the invention is to overcome the disadvantages of the prior art. In particular, it is an object of the invention to provide a baking device which requires a lower maintenance effort and which has a longer service life. Furthermore, it is optionally an object of the invention to provide a baking device which can be operated with greater efficiency in terms of costs and energy. In addition, with the baking device according to the invention, the baking chamber can be better insulated while maintaining the same width of the baking device.

The invention relates to a baking device for producing baked products, wherein the baking device comprises a baking device frame with a baking device housing and a baking chamber arranged within the baking device housing, wherein the baking device has an endless baking tong chain which circulates continuously along an intrinsically closed circulating path and which moves through the baking chamber, wherein the baking tong chain comprises baking tong carriages which are coupled to one another via connecting devices and which have baking tongs that can be opened and closed, in particular swung open and shut, wherein a plurality of rollers are provided, which are connected to the baking tong carriages and/or to the baking tong chain in such a way as to be able to rotate about a roller rotation axis, wherein the rollers roll on at least one vertical guide rail in order to support and vertically guide the baking tong carriages at least along a portion of the circulating path.

It may optionally be provided that at least one lateral guide roller is provided, which is connected to a baking tong carriage and/or to the baking tong chain in such a way as to be able to rotate about a lateral guide roller rotation axis, and/or that the lateral guide roller rolls on at least one lateral guide strip of the baking device in order to laterally guide the baking tong carriage at least along a portion of the circulating path, and/or that the direction of the lateral guide roller rotation axis is at an angle to the direction of the roller rotation axis.

It may optionally be provided that the at least one lateral guide roller is rotatably mounted on the baking tong carriage, and/or that the at least one lateral guide roller is rotatably mounted on the baking tong chain, and/or that the baking tong chain comprises at least one connecting device for coupling in each case two baking tong carriages, the at least one lateral guide roller being rotatably mounted on the connecting device.

It may optionally be provided that the direction of the lateral guide roller rotation axis runs orthogonally to the direction of a roller rotation axis, and/or that the direction of the lateral guide roller rotation axis runs orthogonally to the direction of the nearest roller rotation axis, and/or that the direction of the lateral guide roller rotation axis runs in a normal plane of the vector of the direction of a roller rotation axis.

It may optionally be provided that the direction of the lateral guide roller rotation axis runs orthogonally to the direction of movement of the baking tong carriage along the circulating path, and/or that the direction of the lateral guide roller rotation axis runs in a normal plane of the vector of the direction of movement of the baking tong carriage along the circulating path.

It may optionally be provided that the lateral guide strip is arranged on the baking device frame and/or on the baking device housing.

It may optionally be provided that the lateral guide roller(s) protrude(s) from the baking tong carriage or from the baking tong or from the baking tong chain in the direction of the lateral guide strip(s).

It may optionally be provided that, for laterally guiding a baking tong carriage, a plurality of lateral guide rollers are arranged on a baking tong carriage and/or on the baking tong chain, which lateral guide rollers are in each case guided at least on one side by a lateral guide strip, and/or that, for laterally guiding a baking tong carriage, a lateral guide roller is guided on two opposite sides by a lateral guide strip or by a plurality of lateral guide strips.

It may optionally be provided that the lateral guide strips are arranged on both sides of the baking tong chain on the baking device frame and/or on the baking device housing.

It may optionally be provided that every baking tong carriage or only every second, third, fourth, fifth, sixth, seventh, eighth, ninth or tenth baking tong carriage comprises at least one lateral guide roller, and the other baking tong carriages are configured without lateral guide rollers.

It may optionally be provided that every connecting device or only every second, third, fourth, fifth, sixth, seventh, eighth, ninth or tenth connecting device comprises at least one lateral guide roller, and the other connecting devices are configured without lateral guide rollers.

It may optionally be provided that the baking tongs in each case comprise a baking tong upper part and a baking tong lower part.

It may optionally be provided that two rollers are arranged on one side of a baking tong carriage, and/or that the lateral guide roller for laterally guiding said baking tong carriage is arranged between the two rollers.

It may optionally be provided that four rollers are arranged on each baking tong carriage, and/or that two lateral guide rollers are arranged on each baking tong carriage.

It may optionally be provided that two lateral guide rollers are arranged on each baking tong carriage, protruding therefrom on both sides.

It may optionally be provided that the lateral guide strip is/are arranged on the baking device frame and/or on the baking device housing, and/or that the baking device housing is configured such that it can be opened.

It may optionally be provided that the circulating path, along which the baking tong chain circulates, comprises in succession:
an upper transport plane which runs substantially horizontally,
a rear deflection region,
a lower transport plane which runs substantially horizontally, and
a front deflection region,
   and/or that the baking tong chain in the rear deflection region is guided from the upper transport plane to the lower transport chain by deflection through 180°,
   and/or that the baking tong chain in the front deflection region is guided from the lower transport plane back to the upper transport plane by deflection through 180°,
   and/or that the lateral guide strips are in each case arranged substantially in a straight line along the upper transport plane and along the lower transport plane.

It is preferably provided in all embodiments that at least two lateral guide rollers, which are arranged on both sides of the baking tong chain, roll on at least two lateral guide strips of the baking device, which are arranged on both sides of the baking tong chain, in order to guide the baking tong carriages on both sides at least along a portion of the circulating path.

The construction according to the invention makes it possible in particular that, by moving the baking tong chain, each lateral guide roller can be transported into a region in which it can easily be checked, maintained or replaced. Such a region may be, for example, the front head of the baking device. Such a region may optionally also be the region of the service opening at the rear deflection point of the baking device or a side opening in the region of the baking chamber.

According to different embodiments of the invention, the lateral guide rollers may be provided at different intervals. For example, the lateral guide rollers may be provided on every baking tong carriage or on every second, third or fourth baking tong carriage. In particular, it may also be provided that the lateral guide rollers are arranged in a symmetrical or offset manner along the direction of longitudinal extension of the baking tong chain.

Overall, the lateral guide rollers are intended to achieve lateral guidance of the baking tong chain. To this end, it may be sufficient if the lateral guide rollers are not arranged on every baking tong carriage. The number of lateral guide rollers and thus the cost of manufacturing the baking device can optionally be reduced as a result. The lateral guide rollers may be arranged on the baking tong carriage, in particular directly on a baking plate, or on the lower baking plate. The lateral guide rollers may optionally be provided on a baking tong frame that carries the baking tongs. The lateral guide rollers may optionally also be provided in the region of the connecting devices, via which in each case two baking tongs are connected to one another in order to form a baking tong chain.

According to one preferred embodiment, the lateral guide strips may run along a significant portion of the baking tong chain. Optionally, however, the lateral guide strips are provided only in some sections. Optionally, the lateral guide strips on one side of the baking tong chain are provided in different regions than on the other side of the baking tong chain. For example, a continuous lateral guide strip may be provided on one side of the oven, and on the other side the lateral guide strips provide lateral guidance only in some sections, in order to facilitate accessibility and easier opening.

Further features according to the invention will become apparent from the claims, the description of the exemplary embodiments, and the figures.

The invention will now be explained in greater detail based on the example of non-limiting exemplary embodiments.

### BRIEF DESCRIPTION OF THE DRAWINGS

FIG. 1 shows a schematic diagram of a first embodiment of a baking tong chain of a baking device.

FIG. 2 shows a schematic diagram of a baking tong carriage of a baking tong chain of a baking device, in a side view.

FIG. 3 shows a schematic diagram of an embodiment of a baking device.

FIG. 4a, FIG. 4b, FIG. 4c and FIG. 4d show schematic diagrams of embodiments of baking tong chains of a baking device, wherein the lateral guide rollers are arranged on the baking tong carriages.

FIG. 5a, FIG. 5b and FIG. 5c show schematic diagrams of embodiments of baking tong chains of a baking device, wherein the lateral guide rollers are arranged both on the baking tong carriages and on the baking tong chain.

FIG. 6a, FIG. 6b, FIG. 6c and FIG. 6d show schematic diagrams of baking tong chains of a baking device, wherein the lateral guide rollers are arranged on the baking tong chain.

### DETAILED DESCRIPTION OF EMBODIMENTS

Unless otherwise indicated, the reference signs in the figures correspond to the following components:

baking device 1, baking device frame 2, baking device housing 3, baking chamber 4, baking tong chain 5, baking tong carriage 6, roller 7, roller rotation axis 8, vertical guide rail 9, lateral guide roller 10, lateral guide roller rotation axis 11, lateral guide strip 12, connecting device 13, upper transport plane 14, lower transport plane 15, rear deflection region 16, front deflection region 17, baking tong upper part 18, baking tong lower part 19, baking tong connecting device 20, baking tongs 21.

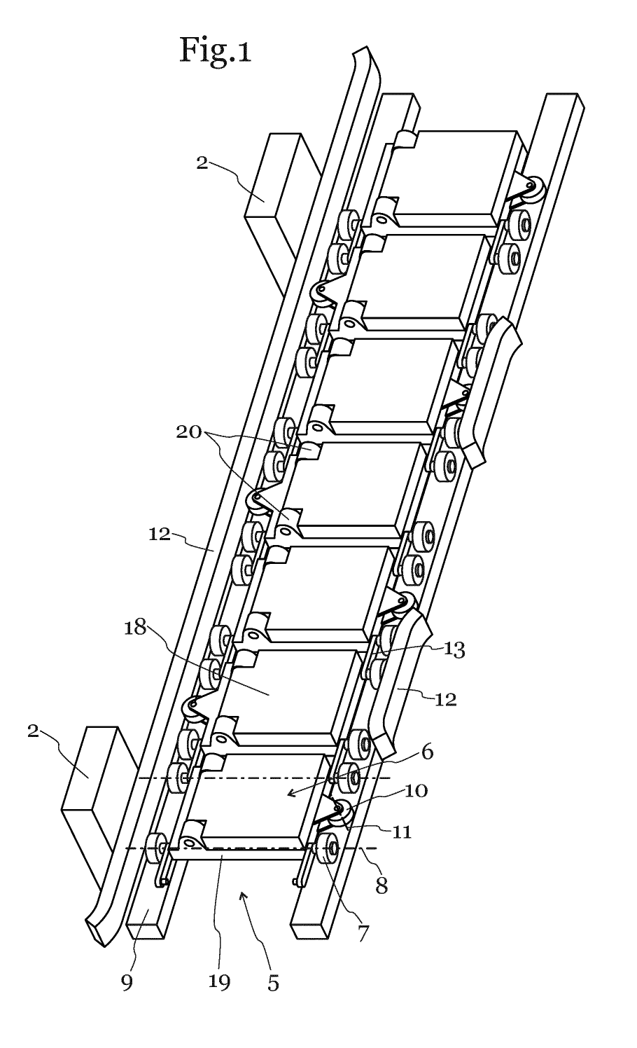

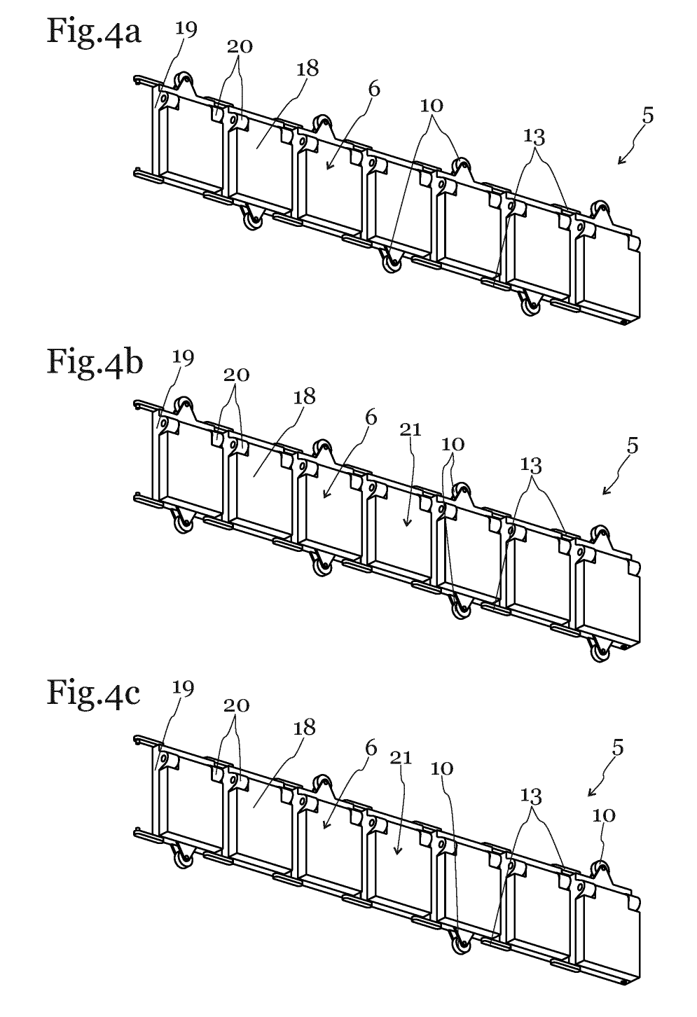

FIG. 1 shows a schematic diagram of parts of a baking device 1 (FIG. 3), including a first embodiment of a baking tong chain 5. The baking tong chain 5 comprises baking tong carriages 6 which are coupled to one another via movable connecting devices 13. Lateral guide rollers 10 are arranged on the baking tong carriages 6, in each case on one side thereof. Said lateral guide rollers 10 roll on at least one lateral guide strip 12 in order to laterally guide the baking tong carriages 6. The lateral guide strips 12 are preferably arranged on the baking device frame 2. The baking tong chain 5 or the baking tong carriages 6 comprise rollers 7 which are arranged in the region of the connecting devices 13.

In particular, the roller rotation axes 8 run coaxially with the axes of articulation of the connecting devices 13. The rollers 7 are rotatably connected to the baking tong chain 5 and to the baking tong carriages 6. The rollers 7 roll on at least one vertical guide rail 9 and serve for supporting and vertically guiding the baking tong carriages 6. Each baking tong carriage 6 comprises a baking tong 21 having a baking tong upper part 18 and a baking tong lower part 19. The baking tong upper part 18 is connected to the baking tong lower part 19 via a baking tong connecting device 20. The lateral guide roller rotation axis 11 is at an angle to the direction of the roller rotation axes 8. According to the embodiment of FIG. 1, it is provided that in each case one lateral guide roller 10 is arranged on every baking tong carriage 6 of the baking tong chain 5, wherein a lateral guide roller 10 on a first baking tong carriage 6 is arranged on a first side of the baking tong carriage 6, and wherein, on the two adjacent baking tong carriages 6 of the baking tong chain 5, the lateral guide rollers 10 are arranged on the side of the baking tong carriage 6 that is opposite to the first side. The lateral guide rollers 10 are arranged in an offset manner along the direction of movement of the baking tong chain 5 and protrude therefrom on alternating sides.

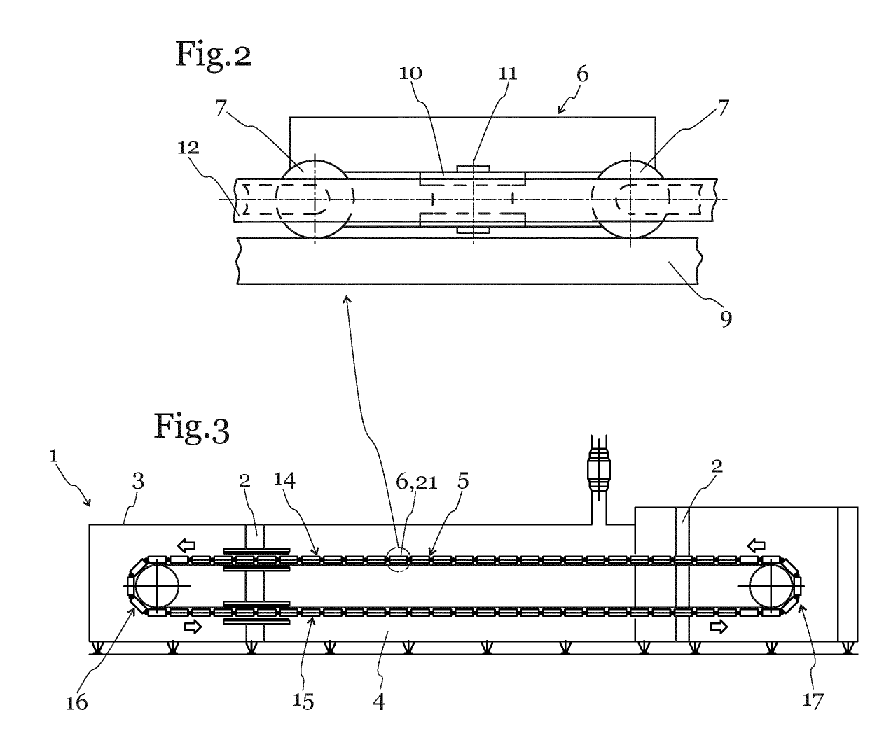

FIG. 2 shows a schematic diagram of a baking tong carriage 6 of a baking tong chain 5 of a baking device 1 according to the invention, in a side view. The baking tong carriage 6 comprises rollers 7. The rollers 7 roll on vertical guide rails 9. The baking tong carriage 6 further comprises a lateral guide roller 10, which is arranged between the two rollers 7. The lateral guide roller 10 is mounted in such a way as to be able to rotate about a lateral guide roller rotation axis 11 and runs on a lateral guide strip 12.

FIG. 3 shows a schematic diagram of an embodiment of a baking device 1 according to the invention. The baking device 1 comprises a baking device frame 2 and a baking device housing 3. The baking chamber 4 is arranged within the baking device housing 3. The baking device 1 has an endless baking tong chain 5 which circulates continuously along an intrinsically closed circulating path and which moves through the baking chamber 4. The baking tong chain 5 comprises baking tong carriages 6. The baking tong carriages 6 comprise baking tongs 21 which o can be opened and closed, in particular swung open and shut. The circulating path, along which the baking tong chain 5 circulates, comprises an upper transport plane 14 which runs substantially horizontally, a rear deflection region 16, a lower transport plane 15 which runs substantially horizontally, and a front deflection region 17. The baking tong chain 5 may be configured according to any embodiment of the invention.

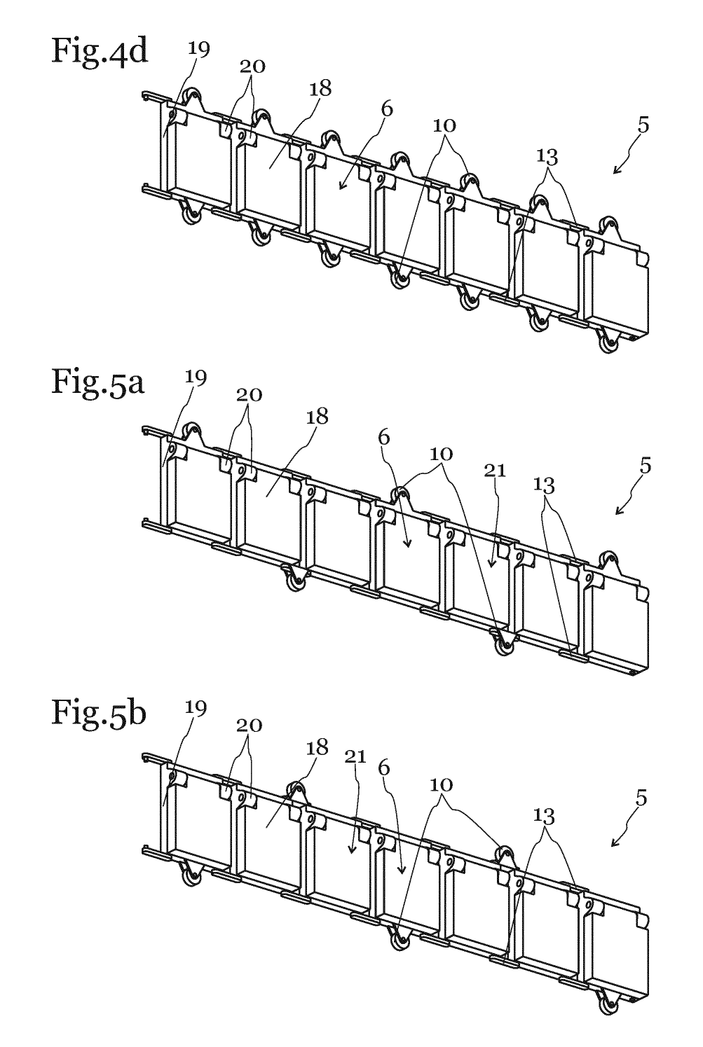

FIG. 4a shows a schematic diagram of a second embodiment of a baking tong chain 5 of a baking device 1 according to the invention. In this embodiment, the lateral guide rollers 10 are arranged only on the baking tong carriages 6. The rollers 7, which may also be arranged on the baking tong carriage 6 and/or on the baking tong chain 5, are not shown for the sake of better clarity. According to this embodiment, it may be provided that in each case one lateral guide roller 10 is arranged on every baking tong carriage 6 of the baking tong chain 5, wherein the lateral guide rollers 10 on a first baking tong carriage 6 of the baking tong chain 5 are arranged on one side of the baking tong carriage 6, and on the baking tong carriage 6 following the first baking tong carriage 6 of the baking tong chain 5 are arranged on the opposite side of the baking tong carriage 6. The baking tong chain 5 comprises baking tong carriages 6 which are coupled, in particular movably, by connecting devices 13. The baking tong carriages 6 comprise baking tong upper parts 18 and baking tong lower parts 19. The baking tong upper parts 18 and baking tong lower parts 19 are connected via baking tong connecting devices 20.

FIG. 4b shows a schematic diagram of a third embodiment of a baking tong chain 5 of a baking device 1 according to the invention. The rollers 7, which may also be arranged on the baking tong carriage 6 and/or on the baking tong chain 5, are not shown for the sake of better clarity. In this figure, it is shown that the lateral guide rollers 10 are arranged on every second baking tong carriage 6 of the baking tong chain 5, the remaining baking tong carriages 6 and the remaining baking tongs 21 being configured without lateral guide rollers 10. The lateral guide rollers 10 protrude outwards in each case on both sides from every second baking tong carriage 6, and hence also every second baking tong carriage 6 comprises no lateral guide rollers 10.

FIG. 4c shows a schematic diagram of a fourth embodiment of a baking tong chain 5 and of a baking device 1 according to the invention, wherein the rollers 7 are once again omitted. In this figure, it is shown that in each case one lateral guide roller 10 is arranged on every second baking tong carriage 6 of the baking tong chain 5, the remaining baking tong carriages 6 and the remaining baking tongs 21 comprising no lateral guide rollers 10. The lateral guide rollers 10 on a first baking tong carriage 6 of the baking tong chain 5 are arranged on a first side of the baking tong carriage 6, and on the next but one baking tong carriage 6 are arranged on the opposite side of the baking tong carriage 6.

FIG. 4d shows a schematic diagram of a fifth embodiment of a baking tong chain 5 of a baking device 1 according to the invention, wherein the rollers 7 are once again omitted. In this figure, it is shown that two lateral guide rollers 10 are arranged on every baking tong carriage 6 of the baking tong chain 5, said lateral guide rollers protruding outwards on both sides from the respective baking tong carriage 6.

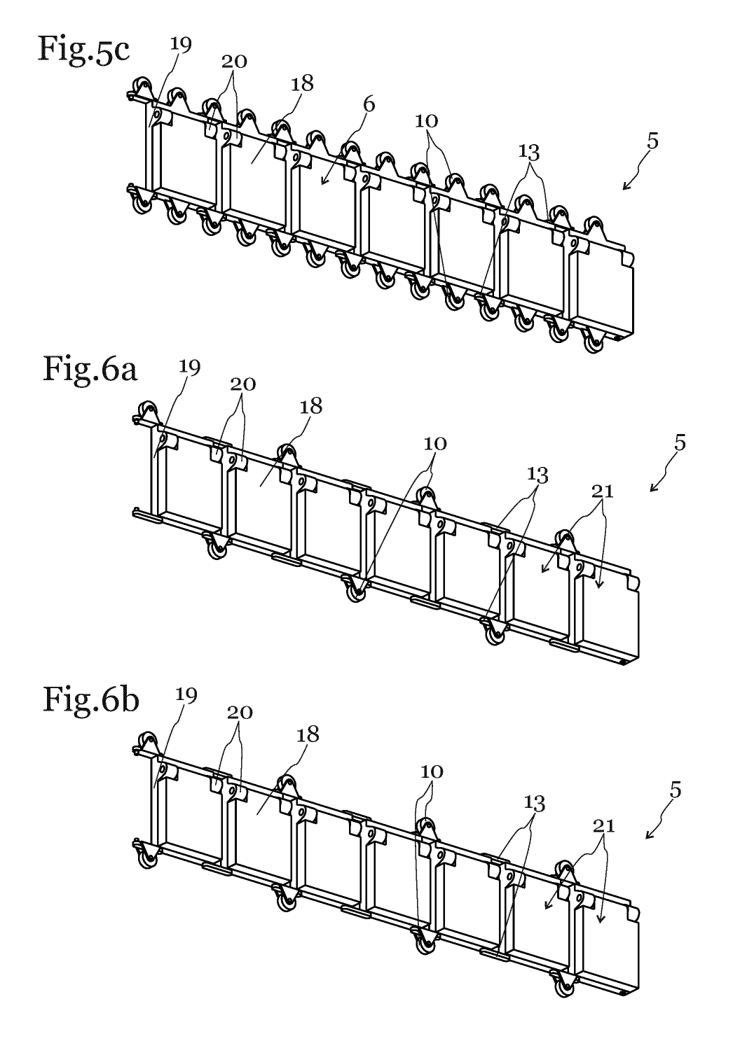

FIG. 5a shows a schematic diagram of a sixth embodiment of a baking tong chain 5 of a baking device 1 according to the invention, with the rollers 7 omitted. In this figure, it is shown that the lateral guide rollers 10 are arranged on the baking tong carriages 6 and on the connecting devices 13 of the baking tong chain 5. In particular, the lateral guide rollers 10 on one side of the baking tong chain 5 are arranged on every third baking tong carriage 6. In addition, the lateral guide rollers 10 on the other side of the baking tong chain 5 are arranged on every third connecting device 13 of the baking tong chain 5.

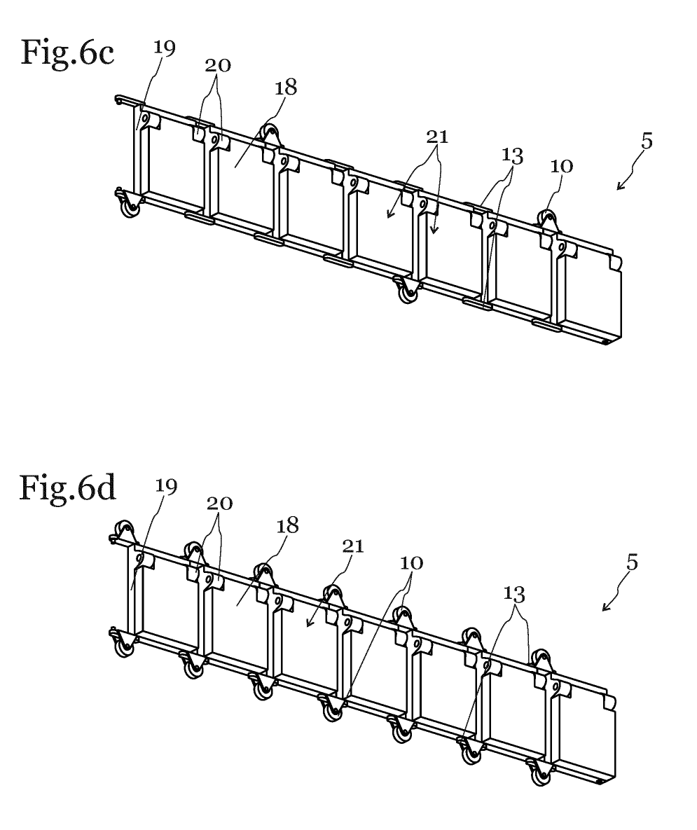

FIG. 5b shows a further schematic diagram of an embodiment of a baking tong chain 5 of a baking device 1 according to the invention, with the rollers 7 omitted, this embodiment being substantially a mirrored embodiment of FIG. 6a.

FIG. 5c shows a schematic diagram of a seventh embodiment of a baking tong chain 5 of a baking device 1 according to the invention, with the rollers 7 omitted.

In this figure, it is shown that the lateral guide rollers 10 are arranged on every baking tong carriage 6 and on every connecting device 13 of the baking tong chain 5, and that the lateral guide rollers 10 are arranged on both sides of the baking tong carriage 6 of the baking tong chain 5.

FIG. 6a and FIG. 6b show schematic diagrams of two further embodiments of baking tong chains 5, with the rollers 7 omitted. In these figures, it is shown that the lateral guide rollers 10 are arranged on every second connecting device 13 on both sides of the baking tong chain 5, the lateral guide rollers 10 being arranged in an offset manner in FIG. 7a and in a symmetrical manner in FIG. 7b.

FIG. 6c shows a schematic diagram of a further embodiment of a baking tong chain 5 of a baking device 1 according to the invention, with the rollers 7 omitted. In this figure, it is shown that the lateral guide rollers 10 are arranged on both sides of the baking tong chain 5, on every fourth connecting device 13 on each side of the baking tong chain 5.

FIG. 6d shows a schematic diagram of a further embodiment of a baking tong chain 5 of a baking device 1 according to the invention, with the rollers 7 omitted. In this figure, it is shown that the lateral guide rollers 10 are arranged on both sides on every connecting device 13 of the baking tong chain 5.

In all embodiments, the lateral guide strips 12 may be arranged on the baking device housing 3. In all embodiments, the lateral guide strips 12 may be arranged on the baking device frame 2 and/or on the baking device housing 3. In all embodiments, at least one roller 7 may be arranged on the baking tong carriage 6.

In an embodiment which is not shown, at least one roller 7 is arranged on the baking tong upper part 18 or on the baking tong lower part 19. In an embodiment which is not shown, at least one lateral guide roller 10 is arranged on the baking tong upper part 18 or baking tong lower part 19.

In the context of the invention, a baking tong carriage 6 in all embodiments comprises a baking tong 21 and at least one roller 7. Preferably, at least one lateral guide roller 10 is connected to the baking tong 21 itself and/or to a frame carrying the baking tong 21.

The invention is not limited to the exemplary embodiments specifically shown, but rather encompasses all baking devices according to the following claims.

1.-16. (canceled)

17. Baking device (1) for producing baked products, comprising:
a baking device frame (2);
a baking device housing (3);
a baking chamber (4) arranged within the baking device housing (3);
an endless baking tong chain (5) which circulates continuously along an intrinsically closed circulating path and which moves through the baking chamber (4), wherein the baking tong chain (5) comprises baking tong carriages (6) which are coupled to one another via connecting devices (13) and which have baking tongs (21) that can be opened and closed;
a plurality of rollers (7) connected to the baking tong carriages (6) and/or to the baking tong chain (5) and rotatable about a roller rotation axis (8);
a vertical guide rail (9) on which the rollers (7) roll and which supports and vertically guides the baking tong carriages (6) at least along a portion of the circulating path;
at least one lateral guide roller (10) connected to a baking tong carriage (6) and/or to the baking tong chain (5) and rotatable about a lateral guide roller rotation axis (11); and
at least one lateral guide strip on which the lateral guide roller (10) rolls and which, together with the at least one lateral guide roller (10) laterally guides the baking tong carriage (6) at least along a portion of the circulating path, wherein the lateral guide roller has a lateral guide roller rotation axis (11) at an angle to the direction of the roller rotation axis (8).

18. Baking device (1) according to claim 17, wherein the at least one lateral guide roller (10) is rotatably mounted on the baking tong carriage (6).

19. Baking device (1) according to claim 17, wherein the at least one lateral guide roller (10) is rotatably mounted on the baking tong chain (5).

20. Baking device (1) according to claim 17, wherein the baking tong chain (5) comprises at least one connecting device (13) for coupling in each case two baking tong carriages (6), the at least one lateral guide roller (10) being rotatably mounted on the connecting device (13).

21. Baking device (1) according to claim 17 wherein the lateral guide roller rotation axis is orthogonal to the roller rotation axis (8).

22. Baking device (1) according to claim 17, wherein the direction of the lateral guide roller rotation axis (11) is orthogonal to the direction of the nearest roller rotation axis (8).

23. Baking device (1) according to claim 17, wherein the direction of the lateral guide roller rotation axis (11) runs in a normal plane of the vector of the direction of a roller rotation axis (8).

24. Baking device (1) according to claim 17, wherein either the direction of the lateral guide roller rotation axis (11) runs orthogonally to the direction of movement of the baking tong carriage (6) along the circulating path, or the direction of the lateral guide roller rotation axis (11) runs in a normal plane of the vector of the direction of movement of the baking tong carriage (6) along the circulating path.

25. Baking device (1) according to claim 17, wherein the lateral guide strip (12) is arranged on the baking device frame (2) and/or on the baking device housing (3).

26. Baking device (1) according to claim 17, wherein the lateral guide roller(s) (10) protrude(s) from the baking tong carriage (6) or from the baking tong (21) or from the baking tong chain (5) in the direction of the lateral guide strip(s) (12).

27. Baking device (1) according claim 17 wherein the at least one lateral guide roller comprises a plurality of lateral guide rollers (10) arranged on a baking tong carriage (6) or on the baking tong chain (5), and wherein the lateral guide rollers are guided either on one side by at least one lateral guide strip (12), or on two opposite sides by a plurality of lateral guide strips (12).

28. Baking device (1) according to claim 27, wherein the at least one lateral strip comprises a plurality of lateral guide strips (12) arranged on both sides of the baking tong chain (5) on the baking device frame (2) and/or on the baking device housing (3).

29. Baking device (1) according to claim 17, wherein either every baking tong carriage (6) includes that at least one lateral guide roller (10), or wherein only every second, third, fourth, fifth, sixth, seventh, eighth, ninth or tenth baking tong carriage (6) includes that at least one lateral guide roller and the other baking tong carriages (6) are configured without lateral guide rollers (10).

30. Baking device (1) according to claim 20, wherein either every connecting device (13) includes the at least one lateral guide roller (10), or only every second, third, fourth, fifth, sixth, seventh, eighth, ninth or tenth connecting device (13) includes the at least one lateral guide roller (10) and the other connecting devices (13) are configured without lateral guide rollers (10).

31. Baking device (1) according to claim 17, wherein the baking tongs (21) each comprise a baking tong upper part (18) and a baking tong lower part (19).

32. Baking device (1) according to claim 17, wherein two rollers (7) are arranged on one side of a baking tong carriage (6), and the lateral guide roller (10) that laterally guides said baking tong carriage (6) is arranged between the two rollers (7).

33. Baking device (1) according to claim 17, wherein four rollers (7) are arranged on each baking tong carriage (6), and in that two lateral guide rollers (10) are arranged on each baking tong carriage (6).

34. Baking device (1) according to claim 17, wherein two lateral guide rollers (10) are arranged on each baking tong carriage (6), protruding therefrom on both sides.

35. Baking device (1) according to claim 17, wherein the at least one lateral guide strip (12) is/are arranged on the baking device frame (2) and/or on the baking device housing (3), and the baking device housing (3) is configured such that it can be opened.

36. Baking device (1) according to claim 17, wherein the circulating path, along which the baking tong chain (5) circulates, comprises in succession an upper transport plane (14) which runs substantially horizontally, a rear deflection region (16), a lower transport plane (15) which runs substantially horizontally, and a front deflection region (17), and wherein the baking tong chain (5) in the rear deflection region (16) is guided from the upper transport plane (14) to the lower transport chain (15) by deflection through 180°, and in the front deflection region (17) is guided from the lower transport plane (15) back to the upper transport plane (14) by deflection through 180°, and wherein the at least one lateral guide strip comprises a first lateral guide strip (12) arranged substantially in a straight line along the upper transport plane (14) and a second lateral guide strip (12) arranged substantially in a straight line along the lower transport plane (15).
